(19) United States
(12) Patent Application Publication
(10) Pub. No.: US 2026/0203601 A1
(43) Pub. Date: Jul. 16, 2026

(54) SYSTEMS AND METHODS FOR ARTIFICIAL INTELLIGENCE WORKLOAD OPTIMIZATION OPPORTUNITY DETECTION

(71) Applicant: Dell Products L.P., Round Rock, TX (US)

(72) Inventors: Robert C. HERNANDEZ, Morrisville, NC (US); Jake M. LELAND, Round Rock, TX (US); Ryan N. COMER, Round Rock, TX (US)

(73) Assignee: Dell Products L.P., Round Rock, TX (US)

(21) Appl. No.: 19/020,069

(22) Filed: Jan. 14, 2025

(51) Int. Cl. G06N 5/022

(52) U.S. Cl. CPC G06N 5/022

(57) ABSTRACT

An information handling system may include a memory and a processor communicatively coupled to the memory and configured to collect accuracy measurements for an artificial intelligence model executing on a compute node to determine an accuracy for the artificial intelligence model and generate an alert with a recommendation for optimizing execution of the artificial intelligence model based at least on the accuracy.

### TECHNICAL FIELD

The present disclosure relates in general to information handling systems, and more particularly to systems and methods for detecting opportunities to optimize artificial intelligence workloads across compute nodes.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are increasingly used for artificial intelligence. Artificial intelligence, in its broadest sense, is intelligence exhibited by machines, particularly information handling systems. Artificial intelligence is a field of research in computer science that develops and studies methods and software that enable machines to perceive their environment and use learning and intelligence to take actions that maximize their chances of achieving defined goals. Artificial intelligence models are executable programs that detect specific patterns using a collection of data sets. A model may be thought of as an illustration of a system that can receive data inputs and draw conclusions or conduct actions depending on those conclusions. An example of an artificial model is a neural network, which may be a model that makes decisions in a manner similar to the human brain, by using processes that mimic the way biological neurons work together to identify phenomena, weigh options and arrive at conclusions.

As advancements in artificial intelligence infrastructure continue to enable more client-friendly form factors, artificial intelligence model deployments are rapidly diversifying from cloud computing environments to edge computing environments. Artificial intelligence-enabled enterprises have increasingly more freedom to choose where their workloads run, often selecting local and edge deployments for the sake of cost and data protection. However, edge environments present unique challenges.

Artificial intelligence models can be optimized past an acceptable threshold for accuracy. Existing approaches for monitoring infrastructure may not be able to detect when such over-optimization occurs, as existing approaches may only analyze classical metrics (e.g., latency, processor utilization, memory, etc.). Accuracy of a response of a large language model is not a metric monitored by classic tools. However, artificial intelligence infrastructure management could be improved if a fully-saturated environment could add an additional workload by deploying a smaller model.

### SUMMARY

In accordance with the teachings of the present disclosure, the disadvantages and problems associated with existing approaches to deployment of artificial intelligence workloads may be reduced or eliminated.

In accordance with embodiments of the present disclosure, an information handling system may include a memory and a processor communicatively coupled to the memory and configured to collect accuracy measurements for an artificial intelligence model executing on a compute node to determine an accuracy for the artificial intelligence model and generate an alert with a recommendation for optimizing execution of the artificial intelligence model based at least on the accuracy.

In accordance with these and other embodiments of the present disclosure, a method may include collecting accuracy measurements for an artificial intelligence model executing on a compute node to determine an accuracy for the artificial intelligence model and generating an alert with a recommendation for optimizing execution of the artificial intelligence model based at least on the accuracy.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to collect accuracy measurements for an artificial intelligence model executing on a compute node to determine an accuracy for the artificial intelligence model and generate an alert with a recommendation for optimizing execution of the artificial intelligence model based at least on the accuracy.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for executing artificial intelligence workloads, in accordance with embodiments of the present disclosure;

FIGS. 2A and 2B (which may be referred to herein collectively as “FIG. 2”) illustrate a flow chart of an example method for detecting optimization opportunities for deployment of artificial intelligence workloads on compute nodes, in accordance with embodiments of the present disclosure;

FIG. 3 illustrates an example allocation of memory footprints of artificial intelligence workloads across three compute nodes, in accordance with embodiments of the present disclosure;

FIG. 4 illustrates another example allocation of memory footprints of artificial intelligence workloads across three compute nodes, in accordance with embodiments of the present disclosure; and

FIG. 5 illustrates yet another example allocation of memory footprints of artificial intelligence workloads across three compute nodes, in accordance with embodiments of the present disclosure.

### DETAILED DESCRIPTION

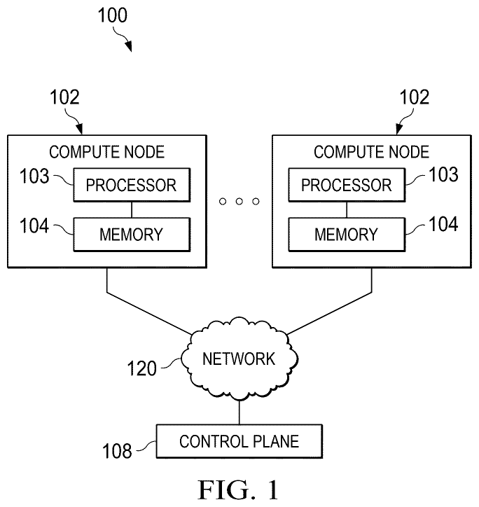

Preferred embodiments and their advantages are best understood by reference to FIGS. 1 through 5, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 for executing artificial intelligence workloads, in accordance with embodiments of the present disclosure. As shown in FIG. 1, system 100 may include a plurality of compute nodes 102, a control plane 108, and a network 120.

Each compute node 102 may comprise an information handling system, as defined above. In operation, each compute node 102 may be configured to execute an artificial intelligence workload using the processing and memory resources thereof. The various compute nodes 102 in system 100 may represent different types of information handling systems within an enterprise. For example, one or more of compute nodes 102 may comprise servers, one or more of compute nodes 102 may comprise client information handling systems (e.g., a laptop, notebook, tablet, handheld, smart phone, personal digital assistant, etc.), one or more of compute nodes 102 may comprise edge devices, and one or more of compute nodes 102 may comprise cloud computing resources.

As depicted in FIG. 1, each compute node may include a processor 103, and a memory 104 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), graphics processing unit (GPU), neural processing unit (NPU), or any other digital or analog circuitry configured to interpret and/or execute program instructions and/or process data. In some embodiments, processor 103 may interpret and/or execute program instructions and/or process data stored in memory 104 and/or another component of a compute node 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to compute node 102 is turned off.

In operation, memory 104 may store all or a portion of an artificial intelligence model, data associated with the model, and executable instructions which may be read and executed by processor 103 to process the data in accordance with the model.

For purposes of clarity and exposition, each compute node 102 is depicted as only including a processor 103 and a memory 104. However, each compute node 102 may comprise other information handling resources not explicitly depicted in FIG. 1.

Control plane 108 may comprise any system, device, or apparatus configured to manage and control execution of artificial intelligence models on the various compute nodes 102. Accordingly, control plane 108 may execute one or more services, including an orchestrator service, for assisting the placement of artificial intelligence workloads for execution among the various compute nodes 102, as described in greater detail below. In some embodiments, control plane 108 may comprise an information handling system distinct from compute nodes 102. In other embodiments, control plane 108 may be a part of and/or executed by one of compute nodes 102. Although not shown in FIG. 1, control plane 108 may also include a processor (e.g., similar to processor 103), memory (e.g., similar to memory 104) and other information handling resources.

Network 120 may comprise a network and/or fabric configured to communicatively couple compute nodes 102 and control plane 108 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In operation, control plane 108 may combine classic metrics (processor types, memory, disk, latency) with artificial intelligence accuracy measurements (perplexity, user feedback, benchmarks, etc.) derived from caching inference responses, user feedback, and other analytic tools in order to notify information technology decision makers, auto-scalers, or other event handlers of opportunities for optimizations which may be deployed to system 100 to maximize utility without degrading the services below acceptable tolerances.

For example, control plane 108 may receive artificial intelligence model configuration parameters, user requests, and system telemetry and based thereon, determine per-instance model statistics (e.g., artificial intelligence model accuracy, artificial intelligence model latency), and based thereon, render a recommendation to update a state of an artificial intelligence model. Artificial intelligence model configuration parameters may include, without limitation, the artificial intelligence models loaded on compute nodes 102, quantization levels of the artificial intelligence models, latency requirements of the artificial intelligence models, and accuracy requirements of the artificial intelligence models. User requests may include, without limitation, user inference requests to loaded artificial intelligence models and inference responses from the loaded artificial intelligence models.

A recommendation may include, without limitation, a recommendation to update a quantization level of an artificial intelligence model, a recommendation to deploy an artificial intelligence model to a different compute node 102, load a larger version of the artificial intelligence model, or free up capacity on a compute node 102.

Control plane 108 may integrate an orchestration tool providing metrics with custom services responsible for tagging requests, caching requests and responses, soliciting user feedback, and analyzing accuracy by executing the measurement frameworks with the cached responses. Control plane 108 may then use these inputs to suggest optimizations to improve the utility of the infrastructure of system 100.

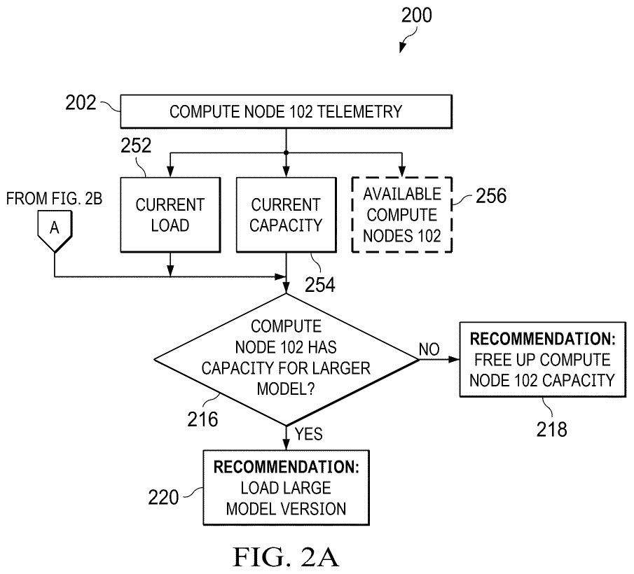

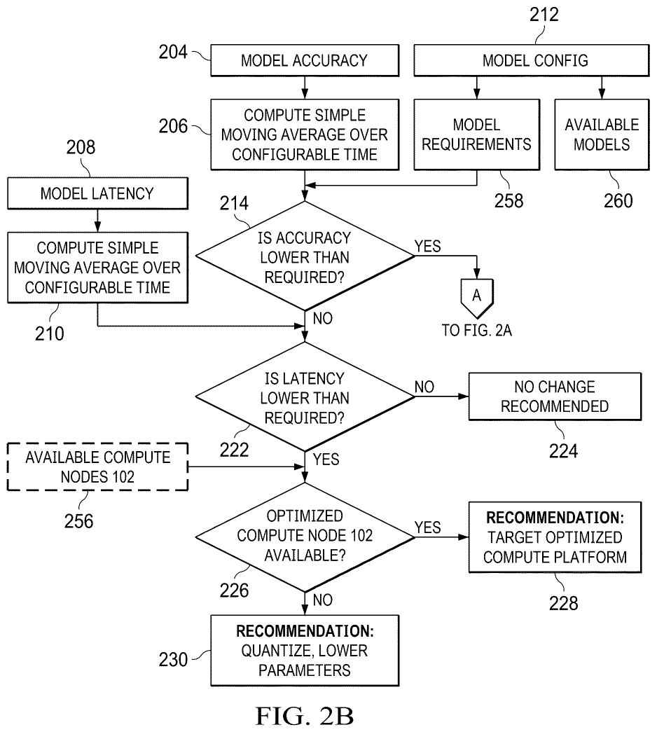

FIG. 2 illustrates a flow chart of an example method 200 for detecting optimization opportunities for deployment of artificial intelligence workloads on compute nodes 102, in accordance with embodiments of the present disclosure. According to some embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, control plane 108 may receive telemetry data for compute nodes 102 and extract information from such telemetry data including current load information 252, current capacity information 254, and available compute node information 256.

At step 204, control plane 108 may receive model accuracy data for the artificial intelligence models executing on compute nodes 102. Such model accuracy data may be derived from feedback requests to a user and/or derived from exercising accuracy evaluation methods for each artificial intelligence model instance. In some embodiments, the model data accuracy may be an aggregated metric combining multiple accuracy metrics such as model perplexity, user feedback, and/or other tools such as OpenAI Eval, and Promptfoo. At step 206, control plane 108 may calculate a simple moving average of the model accuracy metric over a predetermined (and in some embodiments, configurable) period of time.

At step 208, control plane 108 may receive model latency data for the artificial intelligence models executing on compute nodes 102. At step 210, control plane 108 may calculate a simple moving average of the model latency metric over a predetermined (and in some embodiments, configurable) period of time.

At step 212, control plane 108 may receive model configuration data for the artificial intelligence models executing on compute nodes 102. Such model configuration data may include information for each artificial model instance including without limitation a model class, a quantization level, a quantization type, a latency requirement, an accuracy requirement, and/or other information. From such model configuration data, control plane 108 may extract requirements 258 (e.g., latency, accuracy) for each artificial model instance and extract available artificial models 260 executing on compute nodes 102.

At step 214, control plane 108 may, for each artificial model instance, determine if the model accuracy for the model instance (as indicated by the calculated simple moving average) exceeds the required accuracy for the model instance (as indicated in model requirements 258). If the model accuracy is lower than required, method 200 may proceed to step 222. Otherwise, method 200 may proceed to step 216.

At step 216, control plane 108 may determine (e.g., based on current capacity information 254) if the compute node 102 upon which the artificial intelligence model is executing has capacity for a larger model. If the compute node 102 does not have capacity for a larger model, method 200 may proceed to step 218. If the compute node 102 does have capacity for a larger model, method 200 may proceed to step 220.

At step 218, control plane 108 may issue a recommendation to free up capacity on the compute node 102 upon which the model is executing, in order to enable higher accuracy. After completion of step 218, method 200 may end.

At step 220, control plane 108 may issue a recommendation to load a larger model on the compute node 102 upon which the model is executing, in order to enable higher accuracy. After completion of step 220, method 200 may end.

At step 222, control plane 108 may determine if the model latency for the model instance (as indicated by the calculated simple moving average) exceeds the required latency for the model instance (as indicated in model requirements 258). If the model latency is lower than required, method 200 may proceed to step 224. Otherwise, method 200 may proceed to step 226.

At step 224, control plane 108 may determine that no recommendation needs to be made. After completion of step 224, method 200 may end.

At step 226, control plane 108 may determine, based on the inventory of available compute nodes 256, whether an optimized compute node 102 is available for the artificial intelligence model instance. If an optimized compute node 102 is available, method 200 may proceed to step 228. Otherwise, method 200 may proceed to step 230.

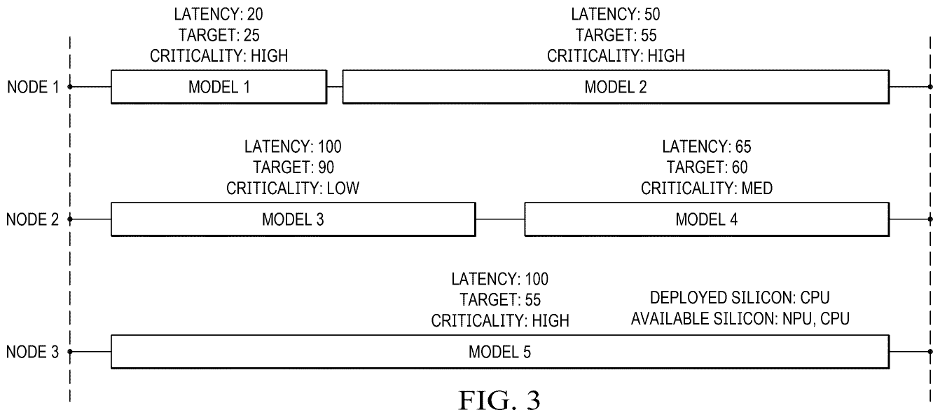

At step 228, control plane 108 may issue a recommendation to suggest a new target compute node 102 for the artificial intelligence model instance. To illustrate, FIG. 3 illustrates an example allocation of memory footprints of artificial intelligence workloads across three compute nodes 102, in accordance with embodiments of the present disclosure. In FIG. 3, artificial intelligence Models 1 through 4 may be operating within an acceptable range for latency. However, Model 5 of FIG. 3 may have a high criticality and may produce results with a latency significantly slower than the configured latency requirement. Accordingly, control plane 108 may issue a suggestion that Model 5 could be potentially replaced with an optimized, compiled version targeting a different compute node 102 (e.g., targeting a neural processing unit of a new compute node 102 instead of the central processing unit of Node 3 upon which Model 5 is presently executing). After completion of step 228, method 200 may end.

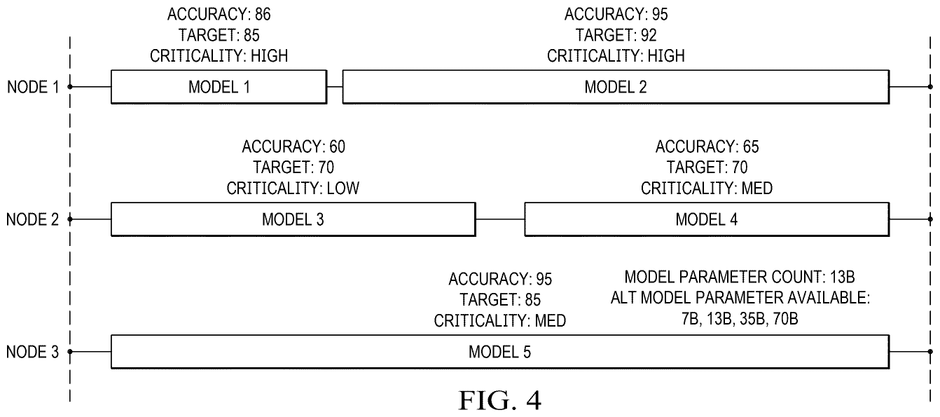

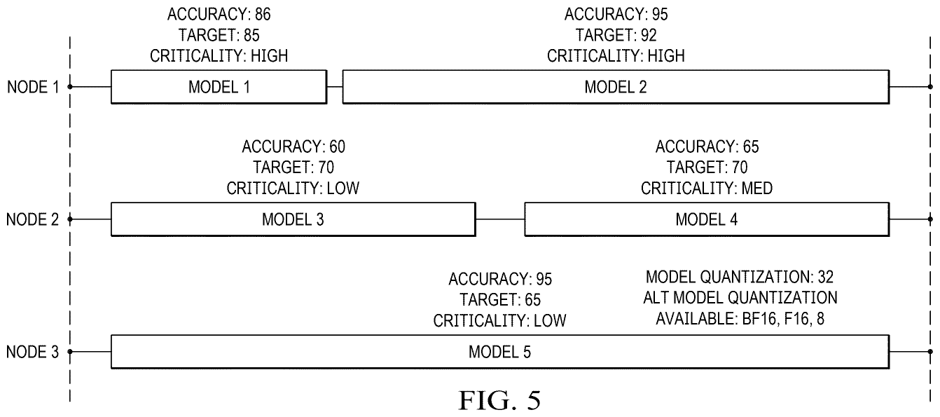

Turning back to FIG. 2, at step 230, control plane 108 may issue a recommendation to update parameters and to update quantization for execution of the artificial intelligence model instance. For example, FIG. 4 illustrates an example allocation of memory footprints of artificial intelligence workloads across three compute nodes 102, in accordance with embodiments of the present disclosure. In FIG. 4, Models 1 through 4 may be operating within an acceptable range for accuracy. However, Model 5 of FIG. 4 may have a medium criticality and may produce results with an accuracy significantly higher than the configured accuracy requirement. Accordingly, control plane 108 may issue a suggestion that Model 5 could be potentially replaced with a lower parameter version without significant impact to performance expectations. As another example, FIG. 5 illustrates an example allocation of memory footprints of artificial intelligence workloads across three compute nodes 102, in accordance with embodiments of the present disclosure. In FIG. 5, Models 1 through 4 may be operating within an acceptable range for accuracy. However, Model 5 of FIG. 4 may have a low criticality and may produce results with an accuracy significantly higher than the configured accuracy requirement. Accordingly, control plane 108 may issue a suggestion that Model 5 could be potentially replaced with a lower-bit, quantized version without significant impact to performance expectations. After completion of step 230, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using a variety of configurations of system 100 and/or any other system operable to implement method 200. In certain embodiments, method 200 may be implemented partially or fully in software and/or firmware embodied in computer-readable media.

The suggestions made herein by control plane 108 may be communicated in any manner or modality, including without limitation a text message alert, electronic mail alert, management dashboard pop-up alert, workflow application programming interface alert, and/or account manager application.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure, For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a memory; and
a processor communicatively coupled to the memory, and configured to:
collect accuracy measurements for an artificial intelligence model executing on a compute node to determine an accuracy for the artificial intelligence model; and
generate an alert with a recommendation for optimizing execution of the artificial intelligence model based at least on the accuracy.

2. The information handling system of claim 1, wherein the recommendation for optimization includes a recommendation to load a larger version of the artificial intelligence model in response to the accuracy being below an accuracy requirement for the artificial intelligence model.

3. The information handling system of claim 1, wherein the recommendation for optimization includes a recommendation to increase capacity of the compute node in response to the accuracy being below an accuracy requirement for the artificial intelligence model.

4. The information handling system of claim 1, wherein the recommendation for optimization includes a recommendation to execute the artificial intelligence model on a second compute node in response to the accuracy being above an accuracy requirement for the artificial intelligence model.

5. The information handling system of claim 1, wherein the recommendation for optimization includes a recommendation to execute the artificial intelligence model with lower parameters in response to the accuracy being above an accuracy requirement for the artificial intelligence model.

6. The information handling system of claim 1, wherein the recommendation for optimization includes a recommendation to execute the artificial intelligence model with a lower quantization in response to the accuracy being above an accuracy requirement for the artificial intelligence model.

7. The information handling system of claim 1, wherein the processor is further configured to:
collect node telemetry for the compute node and a second compute node; and
generate the alert with the recommendation for optimizing execution of the artificial intelligence model based at least on the accuracy and the node telemetry.

8. The information handling system of claim 1, wherein the processor is further configured to:
collect latency measurements for the artificial intelligence model executing on the compute node to determine a latency for the artificial intelligence model; and
generate the alert with the recommendation for optimizing execution of the artificial intelligence model based at least on the accuracy and the latency.

9. A method comprising:
collecting accuracy measurements for an artificial intelligence model executing on a compute node to determine an accuracy for the artificial intelligence model; and
generating an alert with a recommendation for optimizing execution of the artificial intelligence model based at least on the accuracy.

10. The method of claim 9, wherein the recommendation for optimization includes a recommendation to load a larger version of the artificial intelligence model in response to the accuracy being below an accuracy requirement for the artificial intelligence model.

11. The method of claim 9, wherein the recommendation for optimization includes a recommendation to increase capacity of the compute node in response to the accuracy being below an accuracy requirement for the artificial intelligence model.

12. The method of claim 9, wherein the recommendation for optimization includes a recommendation to execute the artificial intelligence model on a second compute node in response to the accuracy being above an accuracy requirement for the artificial intelligence model.

13. The method of claim 9, wherein the recommendation for optimization includes a recommendation to execute the artificial intelligence model with lower parameters in response to the accuracy being above an accuracy requirement for the artificial intelligence model.

14. The method of claim 9, wherein the recommendation for optimization includes a recommendation to execute the artificial intelligence model with a lower quantization in response to the accuracy being above an accuracy requirement for the artificial intelligence model.

15. The method of claim 9, further comprising:
collecting node telemetry for the compute node and a second compute node; and
generating the alert with the recommendation for optimizing execution of the artificial intelligence model based at least on the accuracy and the node telemetry.

16. The method of claim 9, further comprising:
collecting latency measurements for the artificial intelligence model executing on the compute node to determine a latency for the artificial intelligence model; and
generating the alert with the recommendation for optimizing execution of the artificial intelligence model based at least on the accuracy and the latency.

17. An article of manufacture comprising:
a non-transitory computer-readable medium; and
computer-executable instructions carried on the computer-readable medium, the instructions readable by a processor, the instructions, when read and executed, for causing the processor to:
collect accuracy measurements for an artificial intelligence model executing on a compute node to determine an accuracy for the artificial intelligence model; and
generate an alert with a recommendation for optimizing execution of the artificial intelligence model based at least on the accuracy.

18. The article of claim 17, wherein the recommendation for optimization includes a recommendation to load a larger version of the artificial intelligence model in response to the accuracy being below an accuracy requirement for the artificial intelligence model.

19. The article of claim 17, wherein the recommendation for optimization includes a recommendation to increase capacity of the compute node in response to the accuracy being below an accuracy requirement for the artificial intelligence model.

20. The article of claim 17, wherein the recommendation for optimization includes a recommendation to execute the artificial intelligence model on a second compute node in response to the accuracy being above an accuracy requirement for the artificial intelligence model.

21. The article of claim 17, wherein the recommendation for optimization includes a recommendation to execute the artificial intelligence model with lower parameters in response to the accuracy being above an accuracy requirement for the artificial intelligence model.

22. The article of claim 17, wherein the recommendation for optimization includes a recommendation to execute the artificial intelligence model with a lower quantization in response to the accuracy being above an accuracy requirement for the artificial intelligence model.

23. The article of claim 17, the instructions for further causing the processor to:
collect node telemetry for the compute node and a second compute node; and
generate the alert with the recommendation for optimizing execution of the artificial intelligence model based at least on the accuracy and the node telemetry.

24. The article of claim 17, the instructions for further causing the processor to:
collect latency measurements for the artificial intelligence model executing on the compute node to determine a latency for the artificial intelligence model; and
generate the alert with the recommendation for optimizing execution of the artificial intelligence model based at least on the accuracy and the latency.
